(19) United States
(12) Patent Application Publication
(10) Pub. No.: US 2020/0209507 A1
(43) Pub. Date: Jul. 2, 2020

(54) LENS MODULE AND ELECTRONIC DEVICE

(71) Applicant: AAC Optics Solutions Pte. Ltd., Singapore city (SG)

(72) Inventor: Chuandong Wei, Shenzhen (CN)

(21) Appl. No.: 16/706,734

(22) Filed: Dec. 7, 2019

(30) Foreign Application Priority Data
Dec. 29, 2018 (CN) 201822273279.7

(51) Int. Cl. G02B 7/02

(52) U.S. Cl. CPC G02B 7/021; G02B 7/026

(57) ABSTRACT

The present disclosure provides a lens module and an electronic device. The lens module includes a lens barrel and a lens group having an optical axis accommodated in the lens barrel. The lens barrel includes a first barrel body and a second barrel body extendedly disposed from an image side towards an object side, an outer diameter of the first barrel body is greater than an outer diameter of the second barrel body. The first barrel body includes an upper surface close to the object side and an outer wall extending from an edge of the upper surface far away from the optical axis towards the image side. The present disclosure can improve the installation reliability of the lens module and improve the product quality.

### TECHNICAL FIELD

The present disclosure relates to the field of optical imaging technologies, and more particularly to a lens module and an electronic device employing the same.

### BACKGROUND

Most of the existing lens modules are fixed and installed with fixing parts (such as motors) of electronic devices in a threaded connection manner. To be specific, an outside wall of a lens barrel is annularly provided with a thread, a threaded hole is disposed in the fixing part, and the lens module is screwed into the fixing part. However, the lens module connected by threads is easy to loosen when being used for a long time, and the assembly between the lens module and the fixing part is unstable, and has low reliability.

Therefore, it is necessary to provide a lens module to solve the problems of unstable installation and low reliability of the existing lens module.

### BRIEF DESCRIPTION OF THE DRAWINGS

FIG. 1 is an axonometric view of a lens provided by an embodiment of the present disclosure.

FIG. 2 is a top view of the lens provided by the embodiment of the present disclosure.

FIG. 3 is an I-I sectional view in FIG. 2.

### DETAILED DESCRIPTION

The present disclosure is further illustrated hereinafter with reference to the drawings and embodiments.

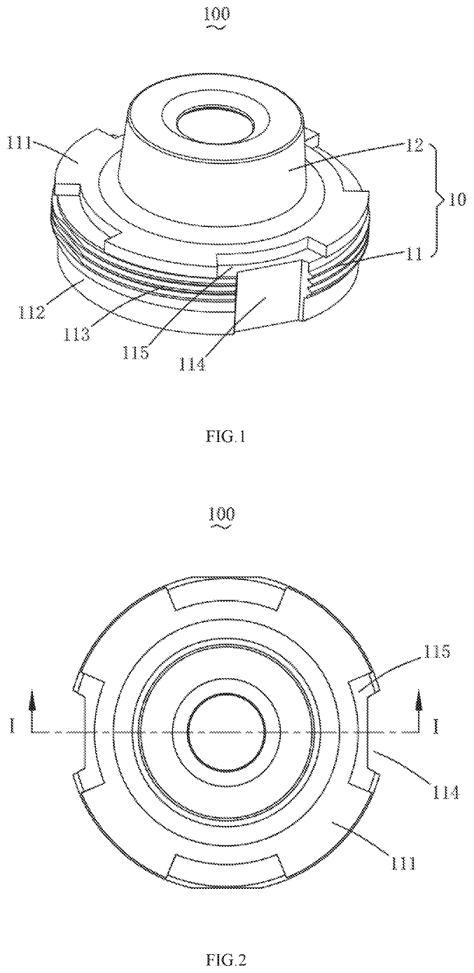

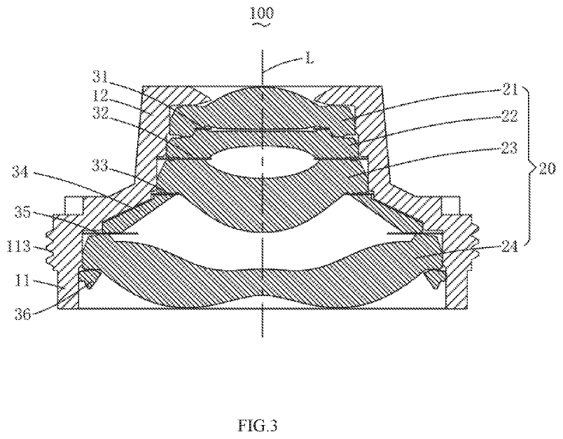

Referring to FIG. 1 to FIG. 3, an embodiment of the present disclosure provides a lens module 100, including a lens barrel 10 and a lens group 20 having an optical axis L accommodated in the lens barrel 10. The lens group 20 includes a first lens 21, a second lens 22, a third lens 23, and a fourth lens 24 stacked from an object side towards an image side in sequence. The lens module 100 further includes a first shade 31 disposed between the first lens 21 and the second lens 22, a second shade 32 disposed between the second lens 22 and the third lens 23, and a third shade 33, a shielding plate 34, and a fourth shade 35 stacked between the third lens 23 and the fourth lens 24 from the object side towards the image side in sequence. On the one hand, the shielding plate 34 is used to absorb false light generated between the third lens 23 and the fourth lens 24 to improve an imaging quality of the lens module 100, and on the other hand, the shielding plate 34 is used to adjust a distance between the third lens 23 and the fourth lens 24. It is understood that the third shade 33, the shielding plate 34 and the fourth shade 35 are not limited to being disposed between the third lens 23 and the fourth lens 24. The third shade 33, the shielding plate 34 and the fourth shade 35 may also be disposed between any other two adjacent lenses according to actual needs. The lens module 100 further includes a pressing ring 36 disposed on an image side of the fourth lens 24.

It should be noted that the lens group 20 is not limited to including the first lens 21, the second lens 22, the third lens 23 and the fourth lens 24 mentioned above. For example, the lens group 20 may be configured to only include the first lens 21 mentioned above, or include the first lens 21 and the second lens 22 mentioned above, or include the first lens 21, the second lens 22 and the third lens 23 mentioned above, or even include the four lenses mentioned above, which may be determined according to actual design needs.

As an improvement of the embodiment, the lens barrel 10 includes a first barrel body 11 and a second barrel body 12 extendedly disposed from an image side towards an object side in sequence, an outer diameter of the first barrel body 11 is greater than an outer diameter of the second barrel body 12, the first barrel body 11 includes an upper surface 111 close to the object side and an outer wall 112 extending from an edge of the upper surface 111 far away from the optical axis towards the image side, the outer wall 112 is provided with a thread 113, the outer wall 112 is recessed towards the optical axis L to form at least one recess 114, and the recess 114 extends to the upper surface 111 and separates the thread 113. According to the design manner, at least one recess 114 is formed by recessing the outer wall of the first barrel body 11 towards the optical axis L; in this way, when the lens module 100 is installed on a fixing part of an electronic device, glue can be filled in the recess 114 to bond the lens module 100 and the fixing part, thus improving the installation reliability of the lens module 100 and improving the product quality.

As an improvement of the embodiment, the upper surface 111 is recessed toward the image side to form a clamping groove 115. The clamping groove 115 is used for disposing a clamping claw of an installation instrument into the clamping groove 115 to screw the lens module 100 into the fixing part of the electronic device.

As an improvement of the embodiment, the clamping groove 115 is communicated with the recess 114. This design facilitates a glue injection needle to extend into the recess 114 through the clamping groove 115 and fill the glue into the recess 114 after the lens module 100 is installed into the fixing part. It is understood that the clamping groove 115 may also be not communicated with the recess 114. In this arrangement, the glue may be injected into the recess 114 in advance, and then the clamping claw of the installation instrument is clamped in the clamping groove 115 to screw the lens module 100 into the fixing part of the electronic device.

As an improvement of the embodiment, at least two clamping grooves 115 are provided, and the clamping grooves 115 are evenly spaced along a circumferential direction of the first barrel body 11. This design facilitates to arrange the clamping claw of the installation instrument into the clamping groove 115 to screw the lens module 100 into the fixing part of the electronic device.

As an improvement of the embodiment, at least two recesses 114 are provided, at least two recesses 114 are symmetrically distributed along a circumferential direction with respect to the optical axis, and the recesses 114 are correspondingly communicated with the clamping grooves 115 one to one. According to this design, the recess 114 may be used as an auxiliary installation structure, that is, the clamping claw of the installation instrument is clamped in the recess 114 to screw the lens module 100 into the fixing part of the electronic device.

As an improvement of the embodiment, one recess 114 is provided, and the groove 114 is communicated with any one of the clamping grooves 115.

As an improvement of the embodiment, at least two clamping grooves 114 are provided, and the two clamping grooves 114 are evenly spaced along a circumferential direction of the first barrel body 11.

As an improvement of the embodiment, four clamping grooves 115 are provided, and the four clamping grooves 115 are evenly spaced along a circumferential direction of the first barrel body 11.

The embodiments of the present disclosure further provide an electronic device, which includes the lens module 100 as described above and a fixing part for accommodating the lens module 100. The fixing part is in threaded connection with the first barrel body 11, and the recess 114 is filled with glue. The electronic device is a mobile phone or a camera.

The description above is merely the embodiments of the present disclosure, and it should be pointed out that those of ordinary skills in the art may make improvements without departing from the concept of the present disclosure, and all these improvements shall belong to the scope of protection of the present disclosure.

What is claimed is:

1. A lens module, comprising
a lens barrel, and
a lens group having an optical axis accommodated in the lens barrel,
wherein the lens barrel comprises a first barrel body and a second barrel body extendedly disposed from an image side towards an object side,
an outer diameter of the first barrel body is greater than an outer diameter of the second barrel body,
the first barrel body comprises an upper surface close to the object side and an outer wall extending from an edge of the upper surface far away from the optical axis towards the image side,
the outer wall is provided with a thread,
the outer wall is recessed towards the optical axis to form at least one recess, and
the recess extends to the upper surface and separates the thread.

2. The lens module according to claim 1, wherein the upper surface is recessed towards the image side to form a clamping groove.

3. The lens module according to claim 1, wherein the clamping groove is communicated with the recess.

4. The lens module according to claim 2, wherein at least two clamping grooves are provided, and the clamping grooves are evenly spaced along a circumferential direction of the first barrel body.

5. The lens module according to claim 4, wherein at least two recesses are provided, at least two recesses are symmetrically distributed along a circumferential direction with respect to the optical axis, and the recesses are correspondingly communicated with the clamping grooves one-to-one; or,
one recess is provided, and the recess is communicated with any one of the clamping grooves.

6. The lens module according to claim 2, wherein two clamping grooves are provided, and the two clamping grooves are evenly spaced along a circumferential direction of the first barrel body; or,
four clamping grooves are provided, and the four clamping grooves are evenly spaced along the circumferential direction of the first barrel body.

7. An electronic device, comprising a lens module and a fixing part for accommodating the lens module,
wherein the fixing part is in threaded connection with the first barrel body, and a recess is filled with glue;
wherein the lens module comprises a lens barrel and a lens group having an optical axis accommodated in the lens barrel,
the lens barrel comprises a first barrel body and a second barrel body extendedly disposed from an image side towards an object side,
an outer diameter of the first barrel body is greater than an outer diameter of the second barrel body,
the first barrel body comprises an upper surface close to the object side and an outer wall extending from an edge of the upper surface far away from the optical axis towards the image side,
the outer wall is provided with a thread,
the outer wall is recessed towards the optical axis to form at least one recess, and
the recess extends to the upper surface and separates the thread.

8. The electronic device according to claim 7, wherein the upper surface is recessed towards the image side to form a clamping groove.

9. The electronic device according to claim 7, wherein the clamping groove is communicated with the recess.

10. The electronic device according to claim 8, wherein at least two clamping grooves are provided, and the clamping grooves are evenly spaced along a circumferential direction of the first barrel body.

11. The electronic device according to claim 10, wherein at least two recesses are provided, at least two recesses are symmetrically distributed along a circumferential direction with respect to the optical axis, and the recesses are correspondingly communicated with the clamping grooves one-to-one; or,
one recess is provided, and the recess is communicated with any one of the clamping grooves.

12. The electronic device according to claim 8, wherein two clamping grooves are provided, and the two clamping grooves are evenly spaced along a circumferential direction of the first barrel body; or,
four clamping grooves are provided, and the four clamping grooves are evenly spaced along the circumferential direction of the first barrel body.
